(19) United States
(12) Patent Application Publication
(10) Pub. No.: US 2008/0258366 A1
(43) Pub. Date: Oct. 23, 2008

(54) SPRING APPARATUS AND A METHOD OF PROVIDING SUCH

(76) Inventor: ERICK TUTTLE, South Weber, UT (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/736,264

(22) Filed: Apr. 17, 2007

(51) Int. Cl. F16F 1/18; B21F 35/04

(52) U.S. Cl. 267/158; 29/896.9

(57) ABSTRACT

A spring apparatus comprises a substantially linear first segment and a substantially linear center segment, rotatably connected to the first segment by a first bend. A substantially linear second segment is rotatably connected to the center segment by a second bend and has a terminal end spaced apart from the second bend. The terminal end contacts the first segment in a slidable manner as at least one of the second segment and the center segment rotates relative to the first segment to release stored energy.

### BACKGROUND

Many different mechanical structures use a spring to store energy or bias another component in a desired direction. There are many types of springs, and the choice of the specific design and characteristics of a spring should be tailored to a particular application. When the available space for the spring is limited, a simple cantilever spring may he chosen, rather than a coil or other more bulky type of spring. A traditional cantilever spring may not be able to provide desired energy storage or component biasing properties, however, due to the simple design of this type of spring.

### BRIEF DESCRIPTION OF THE DRAWINGS

FIG. 1 is a side view of a spring according to a first embodiment of the present invention in an expanded condition.

FIG. 2 is a side view of the spring according to the first embodiment of the present invention in a compressed condition.

FIG. 3 is a cross-sectional view taken along line 3-3 of FIG. 2.

FIG. 4 is a stored energy schematic of the spring according to the first embodiment of the present invention in the compressed condition.

FIG. 5 is a partial perspective view of a spring according to a second embodiment of the present invention in an expanded condition.

FIG. 6 is a side view of a handle assembly including the spring according to the second embodiment of the present invention in a compressed condition.

FIG. 7 is a side view of a handle assembly including the spring according to the second embodiment of the present invention in the expanded condition.

FIGS. 8-11 schematically depict at least a partial sequence of providing a spring according to the first embodiment of the present invention.

### DETAILED DESCRIPTION

FIG. 1 depicts a first embodiment of a spring 100 in an expanded condition. The spring 100 includes a substantially linear first segment 102 and a substantially linear center segment 104, rotatably connected to the first segment by a first bend 106. The term “rotate” is used herein to denote a curved or arcing movement of a structure as if about an axis—e.g., a revolving, pivoting, circling, hinging, or turning motion, or the like, which may be two-dimensional or three-dimensional. The rotational connections discussed herein, such as that linking the first and center segments 102 and 104, may arise from a plastic or elastic deformation of the connecting material therebetween, such as at the first bend 106. Alternately, the rotational connections may be facilitated by a mechanical linkage (not shown).

The spring 100 also includes a substantially linear second segment 108, rotatably connected to the center segment 104 by a second bend 110. The second segment 108 has a terminal end 112 spaced apart longitudinally from the second bend 110. The terminal end 112 may include a wear feature 114 to help facilitate sliding contact between the terminal end 112 and the first segment 102. The first segment 102, first bend 106, center segment 104, second bend 110, and second segment 108 may be formed as an integral or monolithic structure, or may he provided separately and attached together to form the spring 100.

The wear feature 114, when present, may be a modification, such as the slight bend shown, of the spring 100 material at the terminal end 112. The wear feature 114 may include or consist of a separately provided structure such as a roller (not shown) or ball (not shown), made of any material and fastened to the terminal end 112 in any manner. The wear feature 114 may also or instead include a costing on the terminal end 112 and/or the first segment 102 of a wear-resistant or low-friction material. The terminal end 112 need not contact the first segment 102 at all times during use of the spring.

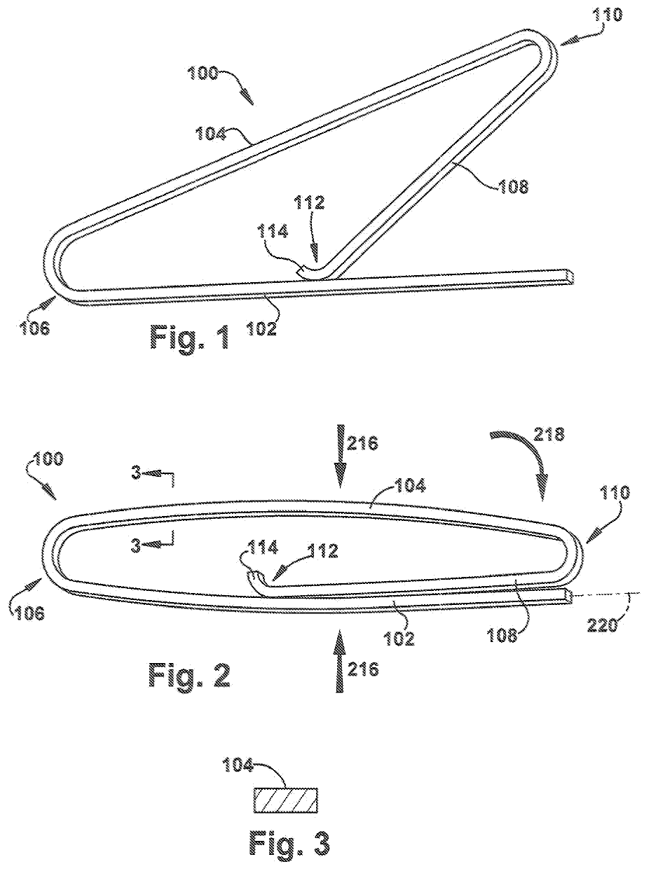

In FIG. 2, the spring 100 has been subjected to a compressive force (generally indicated by compression arrows 216) and is depicted in a compressed condition. For clarity, the following description presumes that the first segment 102 is held stationary and that the center and second segments 104 and 108 move relative to the first segment, with force exerted on and/or by the center segment 104. However, one of ordinary skill in the art could readily design mounting and interface structures to configure the spring 100 in several different orientations. For example, the center segment 104 could be held stationary with the first and second segments 102 and 108 moving relatively thereto, and force could be exerted by or on at least one of the first and second segments. Also for clarity, the description herein will presume that forces are being exerted on, stored in, and released from the spring 100, without differentiation of whether the force is acting on the spring as an internal stress or an external load, and without distinction (except where indicated) of the nature, orientation, or magnitude of the energy. It will be understood that a completely expanded spring will have no stored energy. For example, when energy is stored by an at least partially compressed spring 100 in a similar manner to that shown and described herein, and when that spring 100 is permitted to expand, stored energy may be released from the spring 100 in the form of force exerted on one or more adjacent structures. The released energy may effect a desired result such as facilitating movement of the adjacent structure(s).

The “compressed” and “expanded” conditions of FIGS. 1 and 2 have been chosen to depict the positions and orientations of the structures of the spring 100 in the different conditions. These views do not necessarily show the spring 100 in the most fully expanded or compressed conditions possible, which may depend upon material, preloading, surrounding structures, or other design choices for the spring. In addition, the spring 100 may exist in, or transition through, any of a number of partially compressed and/or expanded conditions between the depicted conditions of FIGS. 1 and 2. Again responsive to design choices, the spring 100 may never reach the depicted conditions of FIGS. 1 and 2 during use in a particular application.

As the spring 100 is compressed from the condition of FIG. 1 to the condition of FIG. 2, at least one of the center and second segments 104 and 108 rotates relative to the first segment 102 in a rotational direction (rotation arrow 218). Both of the center and second segments 104 and 108 will be described hereafter as rotating relative to the first segment 102 for simplicity, but one of the center and second segments 104 and 108 could instead be held stationary during compression and/or expansion, along with the first segment 102. It will be understood that, depending upon which segment 102, 104, and 108 is held stationary, various other segments 102, 104, and 108 can exhibit both translational and rotational motion with respect to the stationary segment 102, 104, and 108. The rotational direction 218 is described without taking any such translational motion into consideration. The rotational direction 218 is depicted as being clockwise in the orientation of FIGS. 1 and 2, but may be either a clockwise or counterclockwise direction, when viewed in two dimensions. Because of the connections provided at the first and second bends 106 and 110, the center and second segments 104 and 108 will (in the absence of any intervening structure) both rotate in the same rotational direction relative to the first segment 102 when the spring 100 moves between the compressed and expanded conditions. The center and second segments 104 and 108, or any other combination of relatively moving segments, may rotate at the same or different rates.

As the center and second segments 104 and 108 rotate relative to the first segment 102 to store energy (while moving from the expanded to compressed conditions) or release stored energy (while moving from the compressed to expanded conditions), the terminal end 112, or a wear feature 114 thereupon, when provided, contacts an adjacent surface of the first segment 102 in a slidable manner. In other words, the terminal end 112 slides along the adjacent surface of the first segment 102 in response to force from the center segment 104 transmitted through the second segment 108. In certain positions of the spring 100, depending upon the specific configuration of the spring and surrounding structures, the second segment 108 may act to support or brace the center segment by transferring force from the center segment 104 into the first segment 102 via the terminal end 112. The first segment 102 may also include constraining means (not shown) to limit the extent or amount of sliding engagement with the terminal end 112.

The first segment 102 may define a longitudinal axis 220 extending therethrough. The center and second segments 104 and 108 may each be oriented substantially parallel to the longitudinal axis 220 when the spring is in the compressed condition, such as shown in FIG. 2. This orientation may be effected by the relative radii of the first and second bends 106 and 110, which may be chosen by one of ordinary skill in the art to produce a desired result. The radii of the first and second bends 106 and 110 may be, hut are not necessarily, substantially similar.

A given one of the first, center, and second segments 102, 104, and 108 may define a spring plane, which is substantially coincident with the plane of the page in the examples of FIGS. 1 and 2. At least one of the other ones of the first, center, and second segments 102, 104, and 108 may then be coplanar with respect to the spring plane. Depending on which one or both of the other ones of the first, center, and second segments 102, 104, and 108 is coplanar with the spring plane, the spring 100 will then be compressible and expandable to store and release energy in a coplanar force direction located within the spring plane (e.g., coplanar with the compression arrows 216 in FIG. 2). In this manner, the spring 100 may be especially useful in an application in which the available mounting space for the spring is limited, particularly mounting space in a direction perpendicular to the spring plane.

The spring 100 may be made of any desired material having the necessary resilience and other physical characteristics for a particular application and may he readily chosen by one of ordinary skill in the art. For example, the spring 100 could be made of metal (e.g., 303 stainless steel), plastic, rubber, a polymer, a ceramic, a composite material (e.g., carbon fiber), or the like, or any combination of these and/or other materials.

The spring 100 could also have any suitable cross-sectional shape, which may vary in different areas of the spring. For instance, any or ail of the first segment 102, the first bend 106, the center segment 104, the second bend 110, and the second segment 108 may have any one or combination of rectilinear, curvilinear, rounded, convex, concave, or any other desired cross-sectional shapes. For example, FIG. 3 depicts a cross-sectional view through a portion of the center segment 104, which is seen to have a rectangular cross-section having a width that is greater than its thickness. It may he advantageous, for example, for the first segment 102 to present a substantially planar surface (i.e., have an at least partially linear cross-section) for the terminal end 112 to slidably engage. Alternatively, the adjacent surface of the first segment 102 may be curved. It will be appreciated that the different opposed surfaces need not have the same contour.

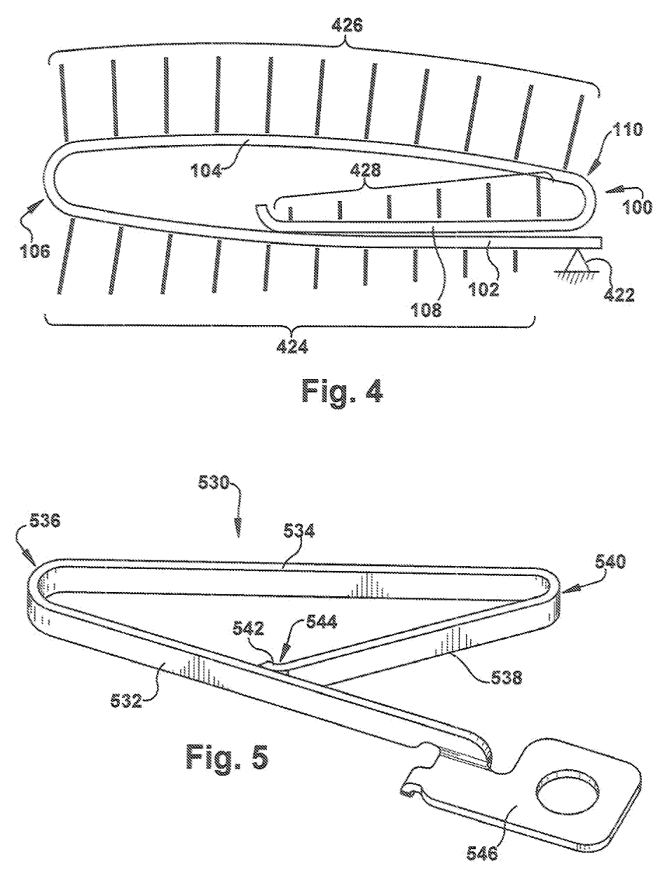

In a conventional cantilever beam type spring, the energy stored within the body of the spring is not stored evenly when the spring is compressed. That is, there is a relatively low amount of energy stored (and available) at the free end of the cantilever spring, and a relatively high amount of energy stored (and available) at the anchored/constrained end of the cantilever spring. In contrast, stored energy in the center segment 104 of the compressed spring 100 is substantially evenly distributed between the ends thereof. By way of example. FIG. 4 is a schematic side elevation of the spring 100 in a compressed condition, similar to FIG. 2, demonstrating possible relative magnitudes of stored energy in the respective spring segments 102, 104, and 108.

In the example of FIG. 4, a tree end of the first segment 102, opposite the first bend 106, is anchored at anchor point 422. The magnitude of stored energy in each spring segment 102, 104, and 108 is schematically depicted by bars 424, 426, and 428, respectively. The stored energy bars 424, 426, and 428 of FIG. 4 are used merely to schematically indicate possible relative magnitudes of stored energy within a spring 100 under compression. Not all stored energy within the spring 100 is represented in FIG. 4 (e.g., there will be some energy at the first and second bends 106 and 110, omitted here for clarity). Like all Figures, FIG. 4 is not necessarily drawn to scale. Unless otherwise constrained, the first and second segments 102 and 108 store energy in a similar manner to that of a conventional cantilever spring.

Finite element analysis (FEA) has shown that stored energy 426 in the center segment 104 is, on average, higher than stored energies 424 and 428 in other portions of the spring 100, and may represent more than half of the total stored energy in the spring. In other words, the stored energy 426 in the second segment 104 may be more than the sum of the stored energies 424 and 428 in the other segments 102 and 108. Additionally, as mentioned above, the energy stored in the second segment 104 (represented by bars 426) is substantially evenly distributed between the ends of such segment. One of ordinary skill in the art may wish to take this property into account when designing a spring 100 for a particular application, in order to optimize material usage and placement or any other properties or characteristics of the spring 100. The relative energy magnitudes and relationships shown schematically in FIG. 4 can be verified independently using FEA or other simulation/analysis tools.

FIG. 5 depicts a second embodiment of a spring 530. While the spring 530 depicted in FIG. 5 appears to be substantially similar to the spring 100 shown and described above with reference to FIGS. 1-4, one of ordinary skill in the art can readily understand that various configurations could have components, arrangements, formats, aspects, and the like different from those shown. For sake of brevity, a description of common elements and their operation similar to those in the previously described to the first embodiment will not be repeated with respect to the example configuration depleted in the second embodiment.

The spring 530 shown in FIG. 5 includes a substantially linear first segment 532 and a substantially linear center segment 534, rotatably connected to the first segment by a first bend 536. The spring 530 also includes a substantially linear second segment 538, rotatably connected to the center segment 534 by a second bend 540. The second segment 538 has a terminal end 542 spaced apart from the second bend 540. The terminal end 542 may include a wear feature 544 to help facilitate sliding contact between the terminal end 542 and the first segment 532. The first segment 532, first bend 536, center segment 534, second bend 540, and second segment 538 may be formed as an integral or monolithic structure, or may be provided separately and attached together to form the spring 530.

As shown in FIG. 5, the spring 530 includes a mounting feature 546 for affixing the first segment 532 to another structure, with such fixation being similar to that presumed in the above description of the operation of the spring 100 of the first embodiment. More broadly and with reference to the second embodiment of the spring 530, one of ordinary skill in the art could readily design a mounting feature (546 or another, not shown) for affixing a given one or more of the first, center, or second segments 532, 534, or 538 to another structure. When such a mounting feature is provided, at least one of the other first center, or second segments 532, 534, or 538 will rotate relative to the selected segment as the spring 530 stores energy (while moving from the expanded to compressed conditions) or releases stored energy (while moving from the compressed to expanded conditions). As can be seen in FIG. 5, the mounting feature 546 may be formed integrally or monolithically with the first, center, and second segments 532, 534, or 538. Alternately, the mounting feature 546 could be provided separately, made of any material or combination of materials, and attached to the rest of the spring 530. The mounting feature 546 may have any suitable dimensions, configuration, or any other characteristic as desired for a particular application of the spring 530.

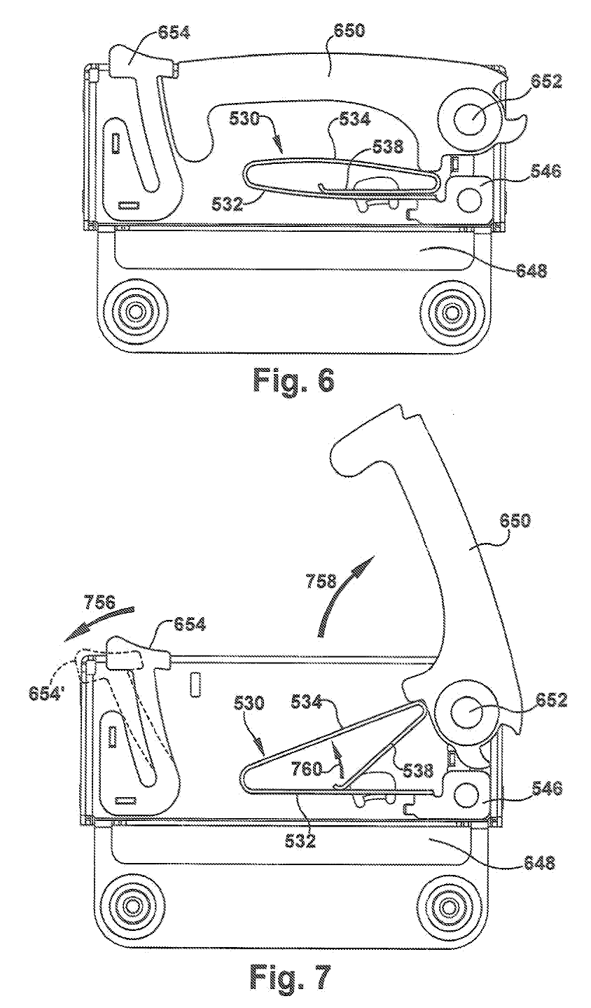

FIGS. 6 and 7 demonstrate an example environment for a spring 530 according to the second embodiment, depicted in FIG. 5. However, one of ordinary skill in the art could readily design or modify a spring 100 according to the first embodiment (depicted in FIGS. 1-4) for use in the example environment of FIGS. 6 and 7 or in any other desired application. FIGS. 6 and 7 depict a spring 530 according to the second embodiment in use in a handle latching application. The mounting feature 546 of the spring 530 is used to affix the spring to a housing 648. A handle 650 is rotatably connected to the housing 648 at handle pin 652. A resilient latch 654 is operative to retain the handle 650 in the handle closed condition shown in FIG. 6. When the handle 650 is closed, the spring 530 is in the compressed condition to bias the handle toward an opened condition and to force the handle 650 into the depicted engagement with the latch 654.

In FIG. 7, the latch 654 has been moved in a latch release direction 756, as shown by the phantom-line latch 654′, to release the handle 650. When the latch 654 disengages from the handle 650, the spring 530 is free to help pivot the handle 650 about the handle pin 652 in a handle release direction 758 and into a handle open position as shown. In other words, the spring 530 is released from the compressed condition of FIG. 6 into the expanded condition of FIG. 7 as the center and second segments 534 and 538 rotate in a spring release direction 760 relative to the first segment 532, which is affixed to the housing 648 by the mounting feature 546. A surface of center segment 534 adjacent the second bend 540 urges a portion of the handle 650 about the pin 652 to effect rotation of the handle. The sequence of FIGS. 6-7 may be reversed to return the handle 650 to the closed position and thus re-compress the spring 530 to store energy for use to re-release the handle 650 at a later time.

In view of the foregoing examples shown and described herein, it is contemplated that the engagement interface between the first segment 102/532 and the terminal end 112/542 could include features (not shown) to enhance operation of the spring 100/530 in a desired application. For example, the first segment 102/532 could be directionally serrated to allow the terminal end 112/542 to slide therealong in one travel direction (i.e., as die spring 100/530 is expanding or compressing) but to resist motion of the terminal end therealong in an opposite travel direction. Such a directional spring may be desirable, for example, when the spring 100/530 is to be used in a one-time or nonreversible application. Similarly, the first segment 102/532 could present a longitudinal ledge or groove (not shown) operative to at least partially engage the terminal end 112/542 and thereby constrain motion thereof to that in the longitudinal direction. In such a manner, the spring 100/530 may be configured, for example, to use in an application in which adjacent structures are not available to separately constrain the motion of the spring within the spring plane.

It is also contemplated that one or more external forces may be exerted on or by the spring 100/530 at any single or multiple locations thereupon. For example, though the spring 530 is depicted in FIGS. 6 and 7 as exerting a biasing force upon a handle 650 from a location near the second bend 540, the spring 530 could also or instead exert a force upon an adjacent structure from any desired location(s) along the center and/or second segments 534 and 538. The choice of location on the spring 100/530 at which the force is exerted may be chosen based upon a factor such as the distance which that location travels with respect to the first segment 102/532. For example, if a relatively long force exertion stroke is desired, the structure against which the force is exerted may be placed along the center segment 104/534 nearer to the second bend 110/540, since the portions of the center segment nearer to the first bend 106/536 are constrained in rotational motion by linkage to the relatively stationary first segment 102/532.

The force exerted by the spring 100/530 may vary in a nonlinear manner through the range of travel of the spring. When the spring 100/530 has reached a full extension region of the range of travel, the force exerted by the spring will be at a minimum and may be nonexistent, depending upon the adjacent structures, if any, interacting with the spring.

The spring 100/530 may be formed in any desired manner. As an example, one method of providing a spring 100 according to the first embodiment of FIGS. 1-4 is shown, at least in part, in the sequence of FIGS. 8-11. A spring 530 according to the second embodiment of FIGS. 5-7 could be provided similarly, but is not shown in FIGS. 8-11. As shown in FIG. 8, a length of resilient material 862 is provided, having an initial end 864 spaced longitudinally apart from a terminal end 112. Continuing in the depicted sequence to FIG. 9, the length, of resilient material 862 is bent at a first position 966 spaced longitudinally apart from the initial end 864 to provide a first bend 106. A first segment 102 is defined between the initial end 864 and the first bend 106 of the length of resilient material 862. The length of resilient material 862 is bent, in FIG. 10, at a second position 1068 spaced longitudinally apart from both the initial end 864 and the first bend 106 to provide a second bend 110. A center segment 104 is defined between the first bend 106 and the second bend 110 of the length of resilient material 862. A second segment 108 is defined between the second bend 110 and the terminal end 112 of the length of resilient material 862. As shown in the close-up view of FIG. 11, the terminal end 112 may be provided with a wear feature 114, such as the depicted bend, to facilitate slidable contact between the terminal end 112 and the first segment 102.

While aspects of the present invention have been particularly shown and described with reference to the preferred embodiment above, it will be understood by those of ordinary skill in the art that various additional embodiments may be contemplated without departing from the spirit and scope of the present invention. For example, the components and structures shown and described may be made of any material, and in any arrangement, configuration, or sizes as desired. The dimensions of the structures of the spring 100/530 may be chosen in response to a magnitude of energy desired to be stored and/or force to be exerted by the spring. Any structures or portions thereof may be coated with substances intended to impart weather-resistance, resilience, friction properties, or any other desired characteristics to the structures. The spring 100/530 could be mounted or anchored at multiple locations thereof. A device or method incorporating any of these features should be understood to fall under the scope of the present invention as determined based upon the claims below and any equivalents thereof.

What have been described above are examples and embodiments of the Invention. It is, of course, not possible to describe every conceivable combination of components or methodologies for purposes of describing the invention, but one of ordinary skill in the art will recognize that many further combinations and permutations of the present invention are possible. Accordingly, the invention is intended to embrace all such alterations, modifications and variations that fall within the scope of the appended claims. In the claims, unless otherwise indicated, the article “a” is to refer to “one or more than one”.

What is claimed is:

1. A spring apparatus, comprising:
a substantially linear first segment;
a substantially linear center segment, rotatably connected to the first segment by a first bend; and
a substantially linear second segment, rotatably connected to the center segment by a second bend and having a terminal end spaced apart from the second bend;
the terminal end contacting the first segment in a slidable manner as at least one of the second segment and the center segment moves relative to the first segment.

2. The spring apparatus of claim 1, further comprising a mounting feature for affixing a selected one of the first, center, and second segments to another structure and wherein at least one of the unselected first, center, and second segments rotates relative to the selected segment.

3. The spring apparatus of claim 1, wherein the terminal end further comprises a wear feature which contacts the first segment in a slidable manner.

4. The spring apparatus of claim 1, being movable between compressed and expanded conditions, wherein the second segment and the center segment both rotate in the same rotational direction relative to the first segment as the spring moves between compressed and expanded conditions of the spring.

5. The spring apparatus of claim 4, wherein the first segment defines a longitudinal axis, and the center segment and the second segment are each oriented substantially parallel to the longitudinal axis when the spring is in the compressed condition.

6. The spring apparatus of claim 1, wherein at least one of the first segment, the first bend, die center segment, the second bend, and the second segment have a rectangular cross-sectional shape.

7. The spring apparatus of claim 1, wherein a given one of the first, center, and second segments defines a spring plane, the other ones of the first, center, and second segments are both coplanar with respect to the spring plane, and stored energy is released by the spring in a coplanar force direction located within the spring plane as the spring apparatus expands from a compressed condition toward an expanded condition.

8. The spring apparatus of claim 3, wherein the first segment, the first bend, the center segment, the second bend, and the second segment are formed integrally.

9. The spring apparatus of claim 1, being movable between compressed and expanded conditions and, when the spring is in the compressed condition, stored energy in the center segment is substantially evenly distributed between spaced apart ends of the center segment.

10. A spring apparatus, comprising:
a substantially linear first segment;
a substantially linear center segment, rotatably connected to the first segment by a first bend; and
a substantially linear second segment, rotatably connected to the center segment by a second bend and having a terminal end spaced apart from the second bend;
the spring being movable between compressed and expanded conditions and, when the spring is in the compressed condition, stored energy in the center segment is substantially evenly distributed.

11. The spring apparatus of claim 10, further comprising a mounting feature for affixing a given one of the first, center, and second segments to another structure and wherein at least one of the other first, center, and second segments rotates relative to the selected segment as the spring releases stored energy.

12. The spring apparatus of claim 10, wherein at least one of the first segment, the first bend, the center segment, the second bend, and the second segment have a rectangular cross-sectional shape.

13. The spring apparatus of claim 10, wherein a given one of the first, center, and second segments defines a spring plane, the other ones of the first, center, and second segments are both coplanar with respect to the spring plane, and stored energy is released by the spring in a coplanar force direction located within the spring plane.

14. The spring apparatus of claim 10, wherein the first segment, the first bend, the center segment, the second bend, and the second segment are formed integrally.

15. The spring apparatus of claim 10, wherein the terminal end contacts the first segment in a slidable manner such that, as the spring moves between the compressed condition and the expanded condition, at least one of the second segment and the center segment rotates relative to the first segment.

16. A method for providing a spring comprising:
providing a length of resilient material having an initial end spaced longitudinally apart from a terminal end;
bending the length of resilient material at a first position spaced longitudinally apart from the initial end to provide a first bend, a substantially linear first segment being defined between the initial end and the first bend of the length of resilient material; and
bending the length of resilient material at a second position spaced longitudinally apart from the initial end and the first bend to provide a second bend, a substantially linear center segment being defined between the first bend and the second bend of the length of resilient material, a substantially linear second segment being defined between the second bend and the terminal end of the length of resilient material, the terminal end contacting the first segment in a slidable manner when the second segment and the center segment rotate relative to the first segment as the spring moves between compressed and expanded states.

17. The method of claim 16, further comprising providing the terminal end with a wear feature contacting the first segment in a slidable manner.

18. The method of claim 16, wherein the spring is movable between compressed and expanded conditions, and wherein the second segment and the center segment both rotate in the same rotational direction relative to the first segment when the spring moves between the compressed and expanded conditions.

19. The method of claim 16, wherein the bending the resilient material at a first position and the bending the resilient material at a second position result in the first segment, the center segment, and the second segment all being coplanar with respect to a force exertion direction of the spring.

20. A spring apparatus produced by the method of claim 16.
